(19) United States
(12) Patent Application Publication
(10) Pub. No.: US 2014/0231724 A1
(43) Pub. Date: Aug. 21, 2014

(54) ACTIVE MATERIAL FOR LITHIUM SECONDARY BATTERY, NEGATIVE ELECTRODE FOR LITHIUM SECONDARY BATTERY, AND LITHIUM SECONDARY BATTERY

(71) Applicants: Tetsuya Osaka, Shinjuku-ku (JP); Toshiyuki Momma, Shinjuku-ku (JP); Tokihiko Yokoshima, Shinjuku-ku (JP); Hiroki Nara, Shinjuku-ku (JP)

(72) Inventors: Tetsuya Osaka, Shinjuku-ku (JP); Toshiyuki Momma, Shinjuku-ku (JP); Tokihiko Yokoshima, Shinjuku-ku (JP); Hiroki Nara, Shinjuku-ku (JP)

(73) Assignee: WASEDA UNIVERSITY, Tokyo (JP)

(21) Appl. No.: 14/007,494

(22) PCT Filed: Mar. 23, 2012
(86) PCT No.: PCT/JP2012/057570

§ 371 Date: Nov. 14, 2013

(30) Foreign Application Priority Data
Mar. 25, 2011 (JP) 2011-068810

(51) Int. Cl. H01M 4/58

(52) U.S. Cl. CPC H01M 4/5825
USPC 252/516

(57) ABSTRACT

An active material for a lithium secondary battery includes an amorphous and metastable phase which contains silicon, oxygen, and more than 30 at % and 80 at % or less of carbon.

### CROSS-REFERENCE TO RELATED APPLICATIONS

This application claims benefit of Japanese Application No. 2011-068810 filed in Japan on Mar. 25, 2011, the entire contents of which are incorporated herein by reference.

### TECHNICAL FIELD

The present invention relates to an active material containing silicon for a lithium secondary battery, a negative electrode for the lithium secondary battery which has the active material for the lithium secondary battery, and a lithium secondary battery which is provided with the negative electrode for the lithium secondary battery.

### BACKGROUND ART

A lithium secondary battery is used as an electric power source of portable electronic equipment and the like. In a common lithium secondary battery, a carbon material which is represented by graphite is used as an active material of the negative electrode. However, in an active material formed from graphite, lithium can be inserted thereinto only up to a range of a composition of LiC₆, and a theoretical energy capacity thereof is 372 mAh/g.

If silicon is used as an active material for increasing the capacity, the theoretical energy capacity per active material of the negative electrode reaches 4,200 mAh/g, which is considered to enable a lithium battery with large capacity to be realized.

However, the negative electrode which uses silicon as the active material causes a large volume change when the battery is charged and discharged, which is accompanied by loss of the active material. Accordingly the capacity decreases with the charge and discharge. For this reason, such methods have been studied as alloying the active material with a third metal, forming a composite of the active material with a carbon material, making the active material a thin film, making the active material porous, roughening the surface of a current collector, and the like.

For instance, Japanese Patent Application Laid-Open Publication No. 2009-231072 proposes a lithium secondary battery in which an active material of a micro-crystal Si or an active material of amorphous Si is formed on a surface-roughened current collector by a method of forming a thin film.

In addition, a process of producing silicon by an electrodeposition method is described in Electrochimica Acta, volume 53, page 111 to page 116, in 2007, but according to the process, porous silicon is deposited from an organic solvent.

In addition, a battery which uses lithium-silicon as an active material for the negative electrode is proposed in Journal of the Solid State Electrochemistry, Online First, published on Dec. 21 in 2008.

However, the market has wanted an active material for a lithium secondary battery, a negative electrode for a lithium secondary battery, and a lithium secondary battery, which show higher energy capacity and more adequate charge-discharge cycle characteristics, for practical use.

Note that a process of producing silicon by an electrodeposition method is disclosed in Japanese Patent Application Laid-Open Publication No. 2006-321688. The above described production method is a molten-salt electrodeposition method which is conducted at 800° C. to 900° C., and aims at obtaining high purity silicon containing 100 ppm or less impurities.

On the other hand, the present invention is directed at providing an active material for a lithium secondary battery, a negative electrode for a lithium secondary battery, and a lithium secondary battery, which show high energy density and adequate charge-discharge cycle-performances.

### DISCLOSURE OF INVENTION

### Means for Solving the Problem

An active material for a lithium secondary battery of an embodiment is an amorphous and metastable phase which contains silicon, oxygen and more than 30 at % and 80 at % or less of carbon.

### BRIEF DESCRIPTION OF THE DRAWINGS

FIG. 1 is a cross-sectional view for describing a configuration of a lithium battery of an embodiment;

FIG. 2 is a schematic view for describing an apparatus for producing a negative electrode of the embodiment;

FIG. 3 is a potential-current curve of an electrolytic solution for an electrodeposition of an active material of the embodiment;

FIG. 4A is an SEM image of the active material of the embodiment, after the active material has been produced;

FIG. 4B is an SEM image of the active material of the embodiment, after the lithium battery has been subjected to first charge;

FIG. 4C is an SEM image of the active material of the embodiment, after the lithium battery has been subjected to a tenth charge-discharge cycle test;

FIG. 4D is an SEM image of the active material of the embodiment, after the lithium battery has been subjected to a 300th charge-discharge cycle test;

FIG. 5 is an XRD chart of the active material of the embodiment;

FIG. 6A is an XPS analysis result of the active material of the embodiment;

FIG. 6B is an XPS analysis result of the active material of the embodiment;

FIG. 6C is an XPS analysis result of the active material of the embodiment;

FIG. 7 is a potential-current curve in CV evaluation of the lithium battery of the embodiment;

FIG. 8 is a result of evaluation for charge-discharge cycle characteristics of the lithium battery of the embodiment; and

FIG. 9 is a result of evaluation for charge-discharge cycle characteristics of the lithium battery of the embodiment.

### BEST MODE FOR CARRYING OUT THE INVENTION

An active material 12 for a lithium secondary battery (hereafter referred to as “active material” as well), a negative electrode 13 for the lithium secondary battery (hereafter referred to as “negative electrode” as well), and a lithium secondary battery 10 (hereafter referred to as “lithium battery” as well) each in the embodiment of the present invention will be described below.

### <Configuration Example of Lithium Secondary Battery>

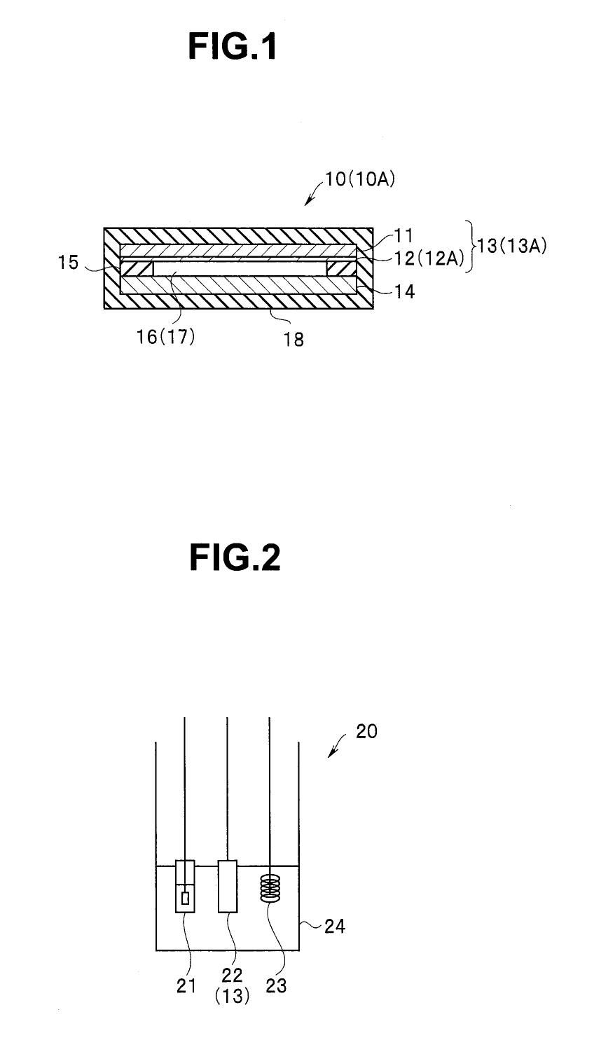

As is shown in FIG. 1, the lithium battery 10 has, for instance, the negative electrode 13 which has the active material 12 formed on a current collector 11, a positive electrode 14, a separator 15 which is arranged between the negative electrode 13 and the positive electrode 14 and forms a storage region 17, an electrolytic solution 16 with which the storage region 17 is charged, and a sealing structure part 18. That is, basic components of the lithium battery 10 are the negative electrode 13, the positive electrode 14 and the electrolytic solution 16.

### <Production of Negative Electrode (Active Material) for Lithium Secondary Battery>

As is shown in FIG. 2, the active material 12 of the embodiment is produced by an electroplating method which is a method of electrochemically forming a film, by using an electrolytic solution 24 that contains SiCl₄. An electrodeposition apparatus 20 uses a platinum wire 23 as an anode and a copper foil 22 as a cathode. The copper foil 22 is the current collector 11 and becomes one part of the negative electrode 13.

As a reference electrode 21, Li/Li⁺ (TBAClO₄) was used. That is, a potential V in the following description is expressed by the potential (vs. Li/Li⁺). In addition, TBA is an abbreviation of tetra-butylammonium. PC (propylene carbonate) in which 0.5 M TBAClO₄ and 0.5 M SiCl₄ were dissolved was used as the electrolytic solution 24.

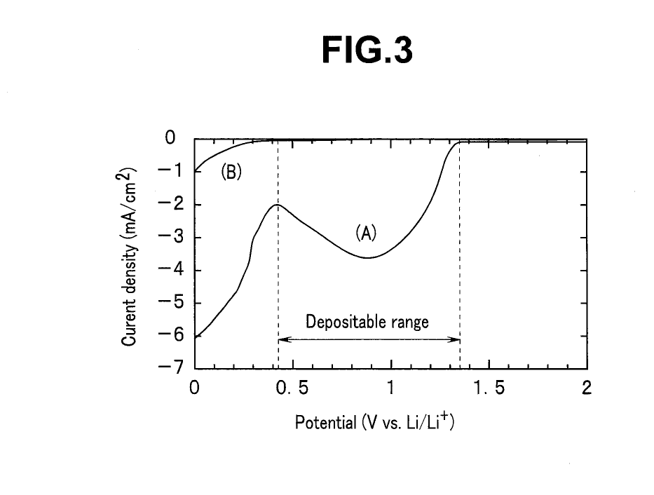

FIG. 3 shows a potential-current curve of the electrodeposition apparatus 20. The curve was measured at a sweep rate of 10 mV/s and in an argon atmosphere having a dew point of −95° C. In FIG. 3, (A) shows a case where the electrolytic solution 24 of the above described composition was used, and (B) shows a case where SiCl₄ was removed from the electrolytic solution 24. As shown in FIG. 3, only in the case of the electrolytic solution 24 containing SiCl₄, a reduction current was recognized in the range of 0.4 to 1.4 V, and it became clear that an electrodeposition reaction of Si proceeded in the above described potential range.

The negative electrode 13 was produced by controlling an electric quantity of passing electric current to 2 C (coulomb)/cm² at a current density of 0.7 mA/cm², and forming the film of the active material 12 on the copper foil 22 of thickness of 80 μm, which was the current collector 11. In addition, for the purpose of comparison, a negative electrode 113 was produced which had an active material 112 formed into a film at a current density of 1.0 mA/cm².

### <Analysis of Active Material for Lithium Secondary Battery>

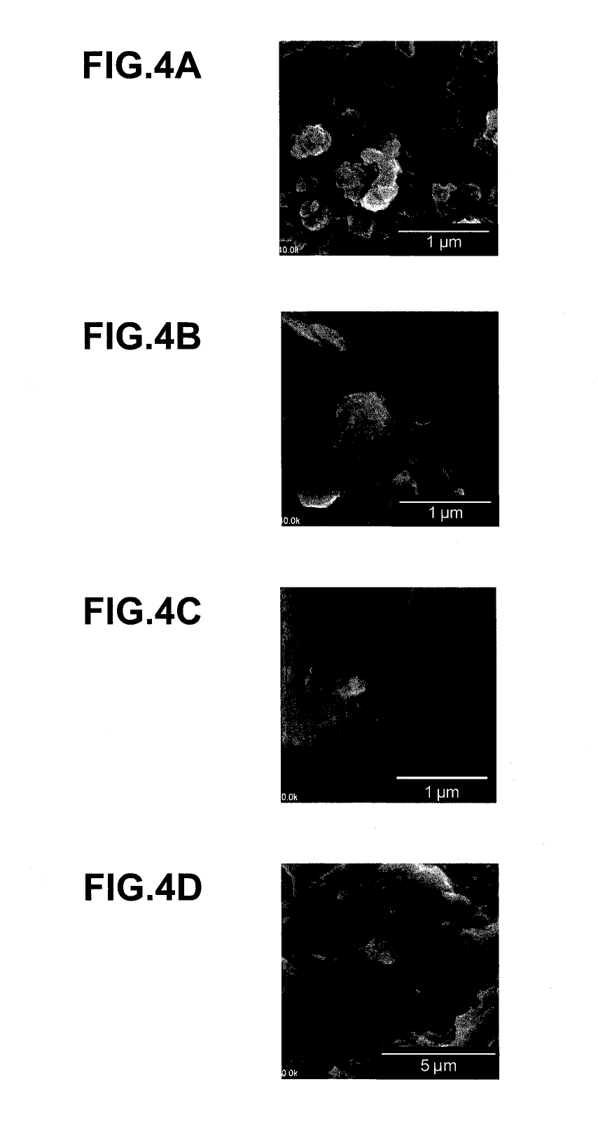

FIG. 4(A) to FIG. 4(D) show photographs of the active material 12 by a scanning electron microscope. FIG. 4(A) shows a photograph after having been produced, FIG. 4(B) shows a photograph after first charge, FIG. 4(C) shows a photograph after a charge-discharge cycle test of ten cycles, and FIG. 4(D) shows a photograph after the charge-discharge cycle test of three hundred cycles.

The active material 12 is particle assemblage, and has a form having voids therein. An in-plane distribution (mapping) of elements which constituted the active material 12 was separately measured by using an energy dispersive X-ray fluorescence analysis apparatus (EDX). As a result, Si, O and C were uniformly distributed.

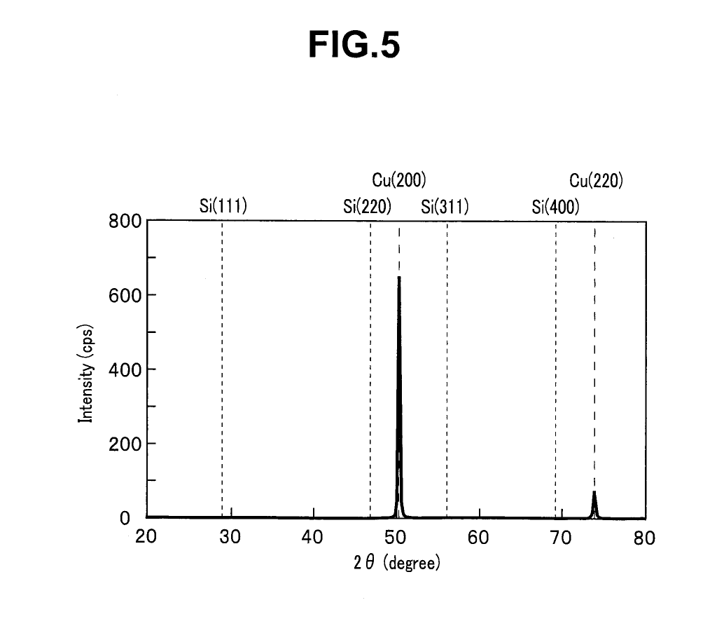

Next, as shown in an analysis result of X-ray diffraction (XRD) of FIG. 5, in the negative electrode 13, any peak was not recognized except peaks of Cu which was a current collector. That is, peaks corresponding to Cu (200) and Cu (220) were recognized, but peaks corresponding to Si (111), Si (220), Si (311) and Si (400) were not recognized.

That is, it became clear that the active material 12 was amorphous (noncrystalline). Note that the term amorphous in the present invention conversely means a state that a peak is not recognized in a usual XRD analysis.

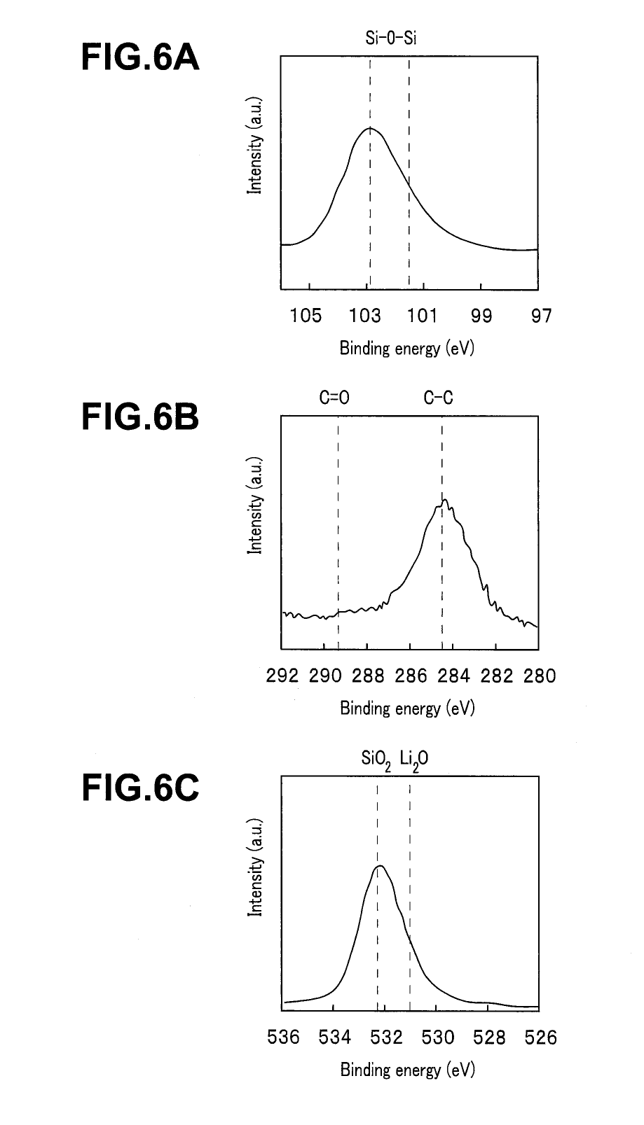

Next, FIG. 6A to FIG. 6C show analysis results of the active material 12 by X-ray photoelectron spectroscopy (XPS). XPS has characteristics of being capable of analyzing not only a type of a constituent element but also the electronic state, and is widely used for an analysis of a thin film.

FIG. 6A shows an intensity distribution of a binding energy range in the vicinity of Si 2p_{3/2}, FIG. 6B shows the distribution of the range in the vicinity of C 1s, and FIG. 6C shows the distribution of the range in the vicinity of O 1s.

As shown in FIG. 6A, the binding energy of Si 2p_{3/2} in the active material 12 is not 99.5 eV which means that the material is Si, nor 103.5 eV which means that the material is SiO₂, but was 101 eV to 103 eV which was a value therebetween.

A Si oxide which has the binding energy of Si 2p_{3/2} of 101 eV to 103 eV is SiO. SiO is not a stable phase such as SiO₂ but a metastable phase in a nonequilibrium state. For this reason, it became clear that Si contained in the active material 12 was a metastable phase, though a structure or the like of SiO was unknown.

Note that a metastable phase is a phase which does not exist in a thermal equilibrium state and is a phase which is thermodynamically unstable but can tentatively exist if some conditions are satisfied.

Next, a composition analysis result of the active material 12 by glow discharge atomic emission spectrochemical analysis (GDOES) will be shown below. Note that the following are values in a place at 1 μm deep from the surface of the active material 12, at which there is little influence of surface contamination and the current collector 11.

Si: 43.5 at %

O: 20.5 at %

C: 36.0 at %

O/Si=0.47

As shown in the analysis results by XPS and GDOES, Si/O of the active material 12 was in a state of SiOx (X=0.47). Note that more strictly, the active material 12 contains a large amount of carbon and accordingly is in a state of “Si—Ox-C_{Y} (X=0.47, Y: unmeasured)”.

On the other hand, the composition of the active material 112 was as follows.

Si: 35.6 at %

O: 45.9 at %

C: 18.5 at %

O/Si=1.29

Here, the active material 12 is produced under an argon atmosphere of a dew point of −95° C., and a moisture content of a solvent is also 10 ppm or less. However, the active material 12 which is an electrodeposited film contains a large amount of oxygen.

In addition, a carbon content which the active material 12 contains obviously exceeds the quantity that is unavoidably mixed. Carbon is an element which is contained in the electrolytic solution 24 (solvent+solute).

That is, oxygen and carbon in the active material 12 are elements which have been formed by an electrolytic decomposition reaction of the electrolytic solution 24 and are co-deposited in the active material 12.

It is reported that an electrodeposition method tends to form a metastable phase in a nonequilibrium state similarly to a high-speed quenching method. Furthermore, the active material 12 contains carbon that comes from the electrolytic solution 24, which has been electrolytically decomposed simultaneously with a deposition reaction. It is reported that the carbon in the electrodeposited film contributes to the formation of the metastable phase in the nonequilibrium state. That is, because the active material 12 has been produced by the e electrodeposition method by using the electrolytic solution 24 that has the solvent or the solute, any of which contains oxygen and carbon and is electrolytically decomposed, the metastable phase is expressed.

The carbon in the active material 12 contributes to making the active material 12 amorphous and the metastable phase.

That is, the active material 12 is not a bulky mixture such as an active material powder+electroconductive auxiliaries+binder, a core shell structure, or a matrix structure of a μm order level, but an amorphous of the metastable phase having the matrix structure of an atom level or a nm order level.

### <Evaluation for Characteristics of Lithium Secondary Battery>

Next, evaluation for characteristics of the lithium battery 10 will be described below.

A tripolar type cell similar to the electrodeposition apparatus 20 was used for the evaluation for the characteristics of the secondary battery. The negative electrode 13 was used as a working electrode, a Li foil was used as a counter electrode, a Li/Li+(TBAClO₄) was used for a reference electrode, and 1 M LiClO₄/EC (ethylene carbonate): PC (1:1 vol %) was used as an electrolytic solution.

In measurement by cyclic voltammetry (CV), a lower limit of potential from an open circuit potential was set at 0.01 V, an upper limit of potential was set at 1.2 V, and a sweep rate was set at 0.1 mV/s. A constant current charge-discharge test (cycle test) was conducted at 50 μA/cm² and in a potential range of 0.01 V to 1.2 V.

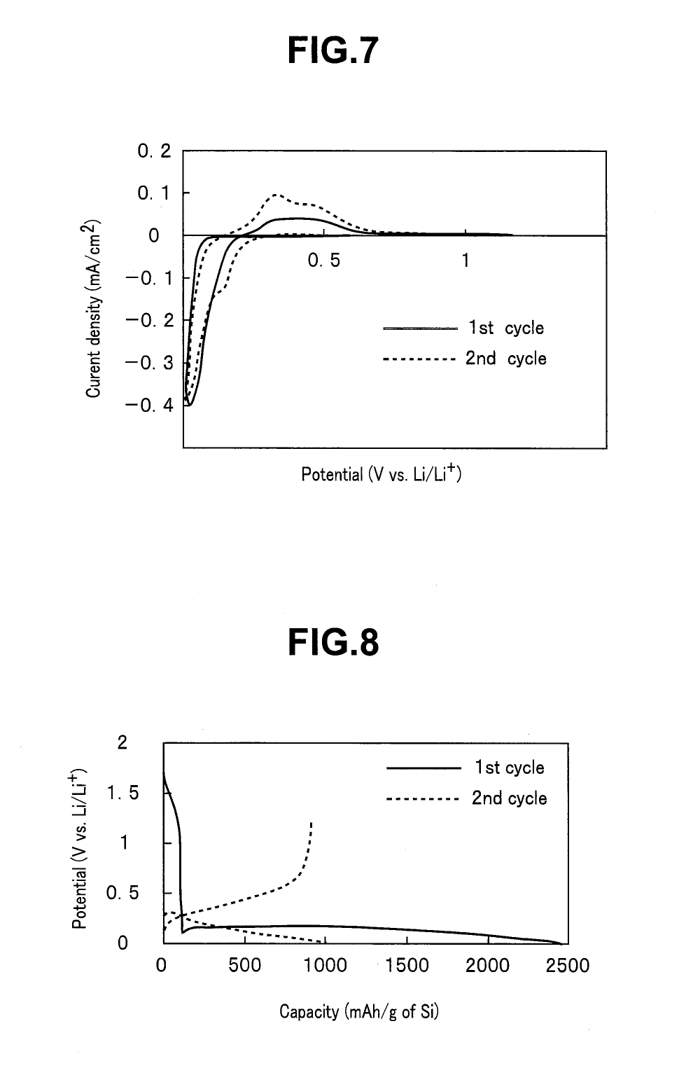

As illustrated in the CV measurement chart in FIG. 7, when the potential was swept to a cathode side, a peak was recognized at 0.01 V which is 0.3 V or less, and when the potential was swept to an anode side, a peak was recognized at 0.3 V and 0.5 V. These peaks coincide with peaks originating in an alloying/dealloying reaction between Si and Li in a lithium battery which uses a known Si negative electrode.

For this reason, in the lithium battery 10, it became clear that the alloying/dealloying reaction between the negative electrode 13 and Li reversibly proceeds.

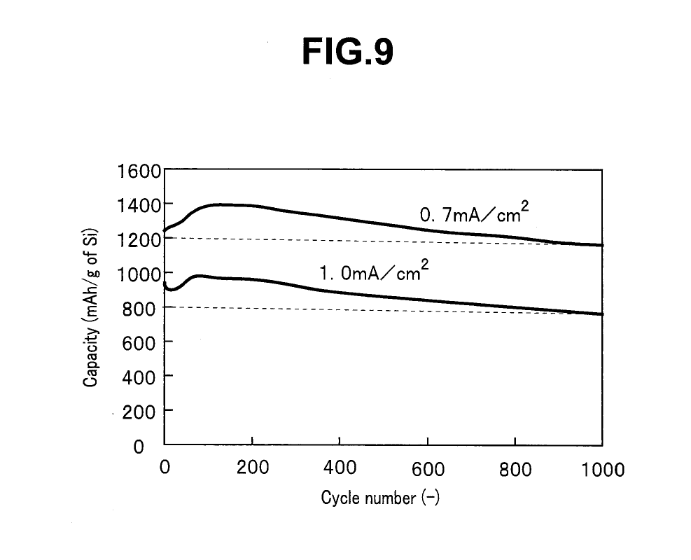

As illustrated in FIG. 8, in the charge-discharge cycle test, only the first cycle characteristics were greatly different from cycle characteristics in the second cycle and later, which were stable. That is, a coulomb efficiency in the first cycle was merely 38%. However, as illustrated in FIG. 9, coulomb efficiencies after two cycles or more were 90% or more, even after 1,000 cycles.

A capacity of the lithium battery 10 is 1,250 mAh/g from an early stage, which is triple or more high-capacity as compared with that of a graphite negative electrode of a known lithium battery. Then, the maximum capacity increased to 1,400 mAh/g. Furthermore, even after the 1,000 cycles, such very stable high characteristics as 1,200 mAh/g were shown. Accordingly, the lithium battery becomes a lithium ion secondary battery having a large capacity than a conventional one.

On the other hand, a capacity of a lithium battery 110 having the active material 112 is such a comparatively high capacity as 1,000 mAh/g per active material of the negative electrode in an early stage. However, the capacity decreased to 600 mAh/g after 1,000 cycles.

Note that the lithium battery 110 having the active material 112 has worse characteristics as compared with the lithium battery 10 having the active material 12, but has higher characteristics as compared with a battery which has been reported so far.

It greatly contributes to the above described characteristics that Si contained in the active material 12 forms a metastable phase in a nonequilibrium state. Hereafter, the metastable phase will be described by way of example of SiOx: X=1. That is, SiO₂ which is a silicon oxide of a stable phase does not have electroconductivity and is electrolytically reduced poorly. On the other hand, SiO has electroconductivity as compared with SiO₂ though being an oxide, and is reduced to Si even though a reducing condition is a grade of a charging condition of a lithium battery. That is, lithium substitutes silicon of SiO to form lithium oxide (Li₂O), in the first charge-discharge cycle.

That is, the following reaction proceeds in the first cycle.

SiO+2Li⁺+2e−→Li₂O+Si (reaction formula 1)

Note that because carbon contained in the active material 12 of the negative electrode 13 gives a great influence on the expression of SiOx which is a metastable phase, the reaction can also be considered as follows.

SiO(—C)+2Li⁺+2e−→Li₂O(—C)+Si(—C) (reaction formula 2)

That is, SiO(—C) of the active material 12 changes into an active material 12A which contains Li₂O(—C), in the first lithium alloy reaction. Then, Si(—C) in the active material 12A repeats a reversible change in subsequent charges and discharges. Note that Li₂O(—C) is an irreversible component which does not change during the charge and discharge.

That is, in a lithium battery 10A provided with a negative electrode 13A, the active material 12A has Li₂O(—C). A reason why the active material 12A having Li₂O(—C) shows excellent cycle characteristics is not clear, but there is a possibility that the active material 12A forms a matrix structure in which Si does not easily desorb from the current collector 11 even when a volume of Si has changed due to the charge and discharge. Alternatively, there is also a possibility that Li₂O(—C) has a function of decreasing a volume change of Si, which originates in the charge and discharge.

Note that it is also considered that a formation of an irreversible component is not preferable in a lithium alloying reaction. This is because a capacity decreases when the irreversible component is formed after the battery has been produced.

However, in the lithium battery 10, the active material 12 is formed on the current collector 11, and accordingly the active material 12 can form Li₂O(—C) therein which is an irreversible component, by making SiO(—C) react with lithium before the battery is produced. In other words, the active material 12 can be changed into the active material 12A.

When the active material 12A is used which contains silicon, oxygen, carbon and lithium in which lithium is a lithium oxide, that is, the active material 12A having Si(—C) and Li₂O(—C) is used, it does not occur that an irreversible component is further formed after the battery has been manufactured. For this reason, the lithium battery 10A can be produced without decreasing the capacity.

In addition, it is also possible to remove lithium which can cause excessive dealloying from the active material 12A, before the lithium battery 10A is produced.

As in the above description, the active material 12A is produced by substituting lithium for silicon of SiOx (X≦1.5) in the active material 12 of the metastable phase. In addition, lithium which the active material 12A contains is a lithium oxide.

In other words, the active material 12A is produced by a process in which the active material is produced from the electrolytic solution 24 which contains a silicon ion, oxygen and carbon, by an electrochemical film-forming method, and is then subjected to the substitution of lithium for silicon by an electrochemical technique.

Furthermore, samples were evaluated which were prepared in different production conditions such as current density, and as a result, the following results were obtained.

The active material 12 becomes an amorphous of a metastable phase, if a carbon content is 10 at % or more. That is, the active material 12A has 10 at % or more of the carbon content which has been calculated with the exclusion of lithium.

In particular, when the active material 12 has more than 30 at % of the carbon content, such high characteristics can be obtained as an initial capacity of 1,100 mAh/g or more and the capacity of 1,000 mAh/g even after 1,000 cycles.

The carbon content is preferably 50 at % or less, and if the carbon content is in the above described range, such high characteristics can be obtained as the initial capacity of 1,100 mAh/g or more and the capacity of 1,000 mAh/g even after 1,000 cycles.

On the other hand, as for Si/O of the active material 12, when an X of SiOx is more than 0 and less than 2, the active material becomes an amorphous of a metastable phase having electroconductivity, and has a possibility of obtaining high characteristics which have not been obtained on the conditions of X=O (Si) or X=2 (SiO₂).

Then, as for Si/O of the active material 12, X of SiOx is preferably 0.1 or more and 1.5 or less. That is, if X is 0.1 or more, the active material is hard to cause loss and the like even when the volume has changed during the charge and discharge. In addition, if X is 1.5 or less, SiOx has sufficient electroconductivity and is also reduced to Si in the first charge-discharge cycle. Accordingly, a high capacity can be obtained.

Furthermore, as for the Si/O of the active material 12, X of SiOx is more preferably 0.2 or more and less than 1.2, and is particularly preferably 0.4 or more and less than 1.2. If X is in the above described range, the lithium battery 10 can obtain such high characteristics as the initial capacity of 1,100 mAh/g or more and 1,000 mAh/g even after 1,000 cycles.

As in the above description, the active materials 12 and 12A for the lithium secondary batteries, the negative electrodes 13 and 13A for the lithium secondary batteries, and the lithium secondary batteries 10 and 10A of the present embodiment respectively show high energy density and adequate charge-discharge cycle characteristics.

Note that structures of the lithium batteries 10 and 10A are not limited to the structure illustrated in FIG. 1 and can employ known various structures.

In addition, the lithium batteries 10 and 10A can also employ a positive electrode that has a composite transition-metal oxide containing lithium such as lithium cobaltate which is generally used in the lithium battery, in place of lithium, as an active material of the positive electrode, as the positive electrode. That is, any active material can be used without being particularly limited, as long as the active material can be used as an active material of a positive electrode of the lithium battery.

In addition, any nonaqueous electrolyte can be used for the lithium batteries 10 and 10A without being particularly limited, as long as the nonaqueous electrolyte can be used for a lithium battery.

The electrolytic solution 24 to be used when the active material 12 is film-formed by electrodeposition is not particularly limited to PC or TBAClO₄, and any electrolytic solution can be used without being particularly limited as long as the electrolytic solution is a solvent or a solute, any of which has oxygen and carbon in a molecular structure and is electrolytically decomposed.

A material for the current collector 11 is not limited to copper, and can employ at least one metal selected from among nickel, stainless steel, molybdenum, tungsten and tantalum, which are generally used in a lithium battery.

In addition, after the active materials 12 and 12A have been produced on a predetermined electroconductive substrate, for instance, on a stainless steel substrate, the active materials 12 and 12A may be peeled from the substrate and be joined to the current collector. For instance, it is also possible to obtain an active material with a long shape by continuously conducting electrodeposition treatment and peeling treatment by using a rotating drum-shaped cathode.

In addition, it is also acceptable to form a composite of an active material peeled from the substrate with a carbon material. That is, it is also acceptable to produce a negative electrode by producing a paste by using an active material, an electroconductive auxiliary and a binder, and applying the paste onto the current collector 11. The active material which has been powdered may also be used.

That is, the present invention is not limited to the above described embodiment, and various modifications, alterations and the like can be made within the range without departing from the gist of the present invention.

1. An active material for a lithium secondary battery, comprising an amorphous and metastable phase which contains silicon, oxygen and more than 30 at % and 80 at % or less of carbon.

2. The active material for the lithium secondary battery according to claim 1, wherein a composition ratio of silicon and oxygen is SiOx (0.1≦X<2).

3. The active material for the lithium secondary battery according to claim 1, wherein the active material is produced from an electrolytic solution which contains a silicon ion, oxygen and carbon, by an electrochemical film-forming method.

4. A negative electrode for a lithium secondary battery, comprising the active material according to claim 1.

5. A lithium secondary battery comprising the negative electrode for the lithium secondary battery according to claim 4.

6. An active material for a lithium secondary battery, which contains silicon, oxygen, more than 30 at % and 80 at % or less of carbon, and lithium, wherein the lithium is a lithium oxide.

7. The active material for the lithium secondary battery according to claim 6, wherein the lithium oxide is produced by substitution of lithium for silicon in SiOx (0.1≦X<2) which forms a metastable phase.

8. The active material for the lithium secondary battery according to claim 6, wherein the active material is produced by a process in which the active material is produced from an electrolytic solution which contains a silicon ion, oxygen and carbon, by an electrochemical film-forming method, and is then subjected to substitution of lithium for silicon with an electrochemical technique.

9. A negative electrode for a lithium secondary battery, comprising the active material for the lithium secondary battery according to claim 6.

10. A lithium secondary battery comprising the negative electrode for the lithium secondary battery according to claim 9.
